(19) United States
(12) Patent Application Publication
(10) Pub. No.: US 2005/0174813 A1
(43) Pub. Date: Aug. 11, 2005

(54) High efficiency power converter with synchronous rectification

(75) Inventors: Sen Dou, Taoyuan Shien (TW); Dong Lin, Taoyuan Shien (TW); Dao Fei Xu, Taoyuan Shien (TW); Jun Duan, Taoyuan Shien (TW); Alpha J. Zhang, Taoyuan Shien (TW)

Correspondence Address: Haverstock & Owens LLP, 162 North Wolfe Road, Sunnyvale, CA, 94086, US

(73) Assignee: Delta Electronics, Inc.

(21) Appl. No.: 11/044,381

(22) Filed: Jan. 26, 2005

Related U.S. Application Data
(60) Provisional application No. 60/542,495, filed on Feb. 6, 2004.

(51) Int. Cl. H02M 3/18

(52) U.S. Cl. 363/59

(57) ABSTRACT

This invention provides an AC-to-DC power converter that improves the overall conversion efficiency especially that at the minimum input ac voltage for universal input operation design by adopting a new combination of control strategies and topologies for the PFC pre-regulator and DC-to-DC converter. The PFC pre-regulator was arranged to provide a regulated bus voltage of which the amplitude is varied in accordance with input ac voltage by a follower boost controller to achieve best efficiency in minimum input ac voltage operation. A synchronous rectifier dual boost PFC pre-regulator was present for further reduction of the power loss in the converter. Symmetrical half-bridge or symmetrical full bridge switch devices were arranged for the primary side of DC-to-DC converter and synchronous rectification circuit with two synchronous rectifier were arranged for the secondary side of the DC-to-DC converter as combination of the AC-to-DC converter. The two synchronous rectifiers were controlled to turn on and turn off complementary to that to the primary half-bridge switch devices to insure a minimized power loss of that converter stage for the extended bus voltage operation design.

### FIELD OF THE INVENTION

The present invention relates to an AC-to-DC power converter, and more specifically to an AC-to-DC power converter with synchronous rectification.

### BACKGROUND OF THE INVENTION

Many electronics appliances, such as computers and consuming electronics, are designed to operate with a direct current (dc) power. Therefore, AC-to-DC power converters are widely used to convert an alternating current (ac) power source into tight regulated dc voltage to supply the appliances.

Please refer to FIG. 1, which shows a typical configuration of an AC-to-DC power converter. An AC-to-DC power converter generally includes two main parts, wherein the first part is a boost type PFC pre-regulator 100′ for providing a regulated bus voltage from a rectified input ac voltage Vᵢₙ, and the second part is a DC-to-DC converter 200′ for providing a tight regulated voltage Vₒᵤₜ from the bus voltage.

The boost type PFC pre-regulator 100′ essentially includes a rectifier (not shown in FIG. 1) and an output capacitor 16′. A boost circuit is inserted between the rectifier and the output capacitor. The boost circuit includes an inductor 10′ followed by a diode 14′ with a switch 12′ connected between ground and a node 13′ between the inductor 10′ and the diode 14′. With an appropriate on/off control of the switch 12′, the current flowing through the inductor 10′ in the PFC circuit will follow the waveform of the rectified input voltage Vin, so that high power factor can be achieved in the ac input side, and meanwhile, a regulated bus voltage can be maintained under different ac voltage input operation. Generally, a constant bus voltage is preferred for optimizing the conversion efficiency of the following part of DC-to-DC converter from the minimized input voltage operation concern.

However, such an arrangement of the boost type PFC pre-regulator 100′ and DC-to-DC converter 200′ still has some problems in controlling and minimizing the overall power losses of the AC-to-DC power converter. Considering the necessity for universal ac voltage input operation of the AC-to-DC power converter, the efficiency of the boost type PFC pre-regulator 100′ will drop dramatically at low input ac voltage due to the large period of on-time of the switch 12′ and results in higher conduction loss in the device. Meanwhile, the DC-to-DC converter is also necessary to be designed for a wide-range bus voltage input operation so that a required holdup time could be achieved when input ac voltage disappears. However, most of the DC-to-DC power converters features in conversion efficiency as lower at higher input voltage but higher at lower input voltage operation, which means that the AC-to-DC power converter will actually show low overall conversion efficiency by said arrangement, and obviously the performance will be the worst in the minimum ac voltage input operation.

The present invention seeks to provide an AC-to-DC power converter architecture which improves the overall conversion efficiency especially that at the minimum input ac voltage for universal input operation design by adopting a new combination of control strategies and topologies for the PFC pre-regulator and DC-to-DC converter. With the new combination of control strategies and topologies, not only improves the conversion efficiency of the boost type PFC pre-regulator for minimum input ac voltage operation, but also improves conversion efficiency of the DC-to-DC converter significantly by employing synchronous rectification in the DC output side.

### SUMMARY OF THE INVENTION

It is a first aspect of the present invention to provide a novel high efficiency AC-to-DC power converter with synchronous rectification. The power converter includes a rectifier for generating a rectified voltage from an ac power source, a boost converter electrically connected to the rectifier for converting the rectified voltage to a regulated bus voltage, a DC-to-DC converter electrically connected to the boost converter for converting the regulated bus voltage to an output voltage, and a controller generating a signal in response to the regulated bus voltage to provide a feedback control over the boost converter, so that the regulated bus voltage is further controlled and regulated.

Preferably, the rectifier is a diode bridge.

Preferably, the boost converter further includes a switch device, an inductor having a first terminal electrically connected to the rectifier and a second terminal electrically connected to an input of the switch device, and a diode and a capacitor connected in series and electrically connected to the switch device in parallel.

Preferably, the switch device further includes a control input terminal electrically connected to the controller for receiving the signal, so that a current is controlled by the switch device to flow through the inductor.

Preferably, the controller is a pulse width modulation circuit having an input terminal for receiving the regulated bus voltage, and having an output terminal coupled to the control input terminal of the switch device to provide a series of pulses for controlling the duty cycle of the switch device.

Preferably, the switch device is a MOSFET device.

Preferably, the DC-to-DC converter further includes a transformer having a primary winding and a secondary winding, bridge switching devices electrically connected to the first winding of the transformer, and a rectification circuit electrically connected to the secondary winding of the transformer.

Preferably, the bridge switching devices are ones of symmetrical half-bridge switching devices and symmetrical full-bridge switching devices.

Preferably, the rectification circuit includes two synchronous rectifiers (SR) and an output filter.

It is a second aspect of the present invention to provide a novel high efficiency AC-to-DC power converter with synchronous rectification. The power converter includes a dual boost converter having a first boost circuits and a second boost circuits respectively and electrically connected to an output terminal and a return terminal of an ac power source for converting an AC input voltage to a regulated bus voltage, a DC-to-DC converter electrically connected to the dual boost converter for converting the regulated bus voltage to an output voltage, and a controller generating a signal in response to the regulated bus voltage to provide a feedback control over the dual boost converter, so that the regulated bus voltage is further controlled and regulated.

Preferably, each of the first and second boost circuits further includes a switch device, an inductor having a first terminal electrically connected to one terminal of the ac input voltage and a second terminal electrically connected to an input of the switch device, and a boost diode having a first terminal electrically connected to a first terminal of an energy storage capacitor and a second terminal electrically connected to the second terminal of the inductor.

Preferably, the switch device further includes a control input terminal electrically connected to the controller for receiving the signal so that a current is controlled by the switch device to flow through the inductor.

Preferably, the controller is a pulse width modulation circuit having an input terminal for receiving the regulated voltage, and having an output terminal coupled to the control input terminal of the switch device to provide a series of pulses for controlling the duty cycle of the switch device.

Preferably, the switch devices are MOSFET devices.

Preferably, the DC-to-DC converter further includes a transformer having a primary winding and a secondary winding, bridge switching devices electrically connected to the first winding of the transformer, and a rectification circuit electrically connected to the secondary winding of the transformer.

Preferably, the bridge switching devices are ones of symmetrical half-bridge switching devices and symmetrical full-bridge switching devices.

Preferably, the rectification circuit includes two synchronous rectifiers (SR) and an output filter.

It is a third aspect of the present invention to provide a method for supplying a dc voltage from an ac power source which reduces the maximum power loss and solves the thermal issue when the power density of the power converter being increased. The method includes steps of rectifying an ac input voltage from the ac power source to produce a rectified voltage, converting the rectified voltage to a regulated bus voltage by means of a boost converter, detecting the regulated bus voltage by means of a controller and generating a signal in response to the regulated bus voltage to provide a feedback control over the boost converter, and converting the regulated bus voltage to an output voltage by means of a DC-to-DC converter.

Preferably, the step of providing a feedback control over the boost converter is to provide a PWM signal for a switch of the boost converter.

The above objects and advantages of the present invention will become more readily apparent to those ordinarily skilled in the art after reviewing the following detailed descriptions and accompanying drawings, in which:

### BRIEF DESCRIPTION OF THE DRAWINGS

FIG. 1 is a schematic diagram of a conventional power converter according to the prior art;

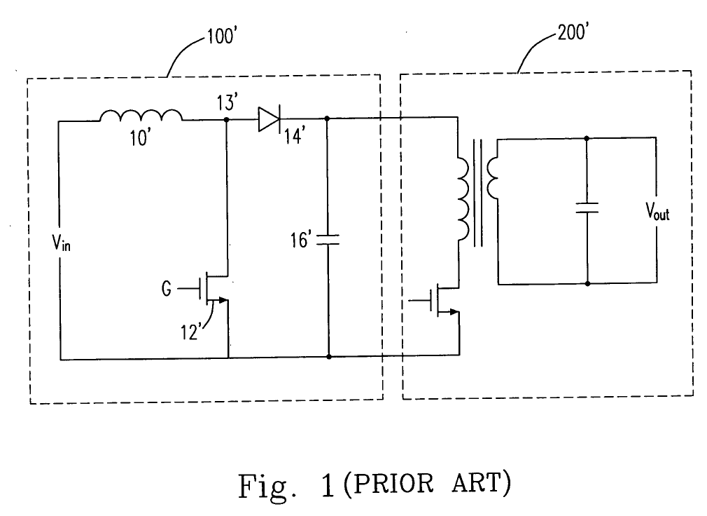

FIG. 2 is a schematic diagram of a power converter in accordance with the first preferred embodiment of the present invention;

FIG. 3 is a schematic diagram of a power converter in accordance with the second preferred embodiment of the present invention;

FIG. 4 is a schematic diagram of a power converter in accordance with the third preferred embodiment of the present invention; and

FIG. 5 is a schematic diagram of a power converter in accordance with the fourth preferred embodiment of the present invention.

### DETAILED DESCRIPTION OF THE PREFERRED EMBODIMENT

The present invention will now be described more specifically with reference to the following embodiments. It is to be noted that the following descriptions of preferred embodiments of this invention are presented herein for purpose of illustration and description only; it is not intended to be exhaustive or to be limited to the precise form disclosed.

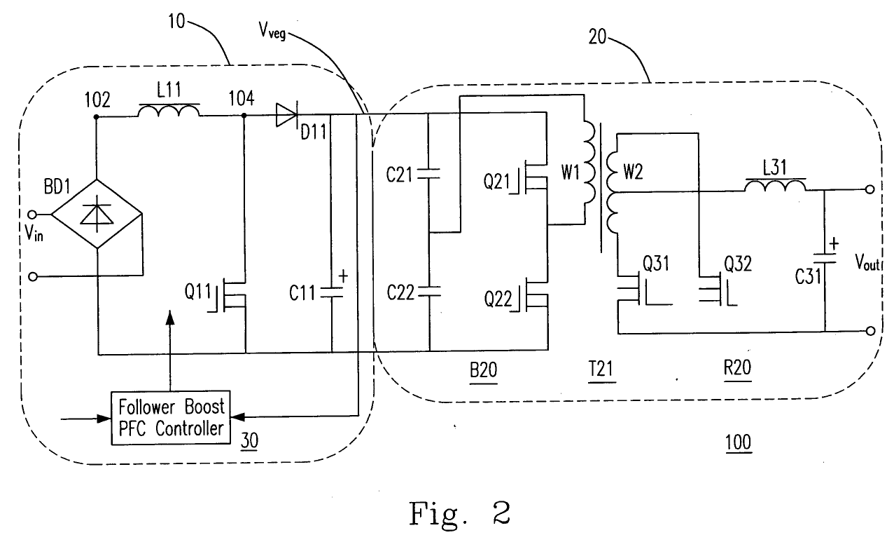

Please refer to FIG. 2, which shows a schematic diagram of a power converter according to the first preferred embodiment of the present invention. The power converter is composed by a boost type PFC pre-regulator 10 and a DC-to-DC converter 20. The boost type PFC pre-regulator 10 is employed to rectify an ac input voltage Vᵢₙ, then draw a sinusoidal input current from the ac input voltage Vᵢₙ to meet the limits of harmonic current emission, and output a regulated bus voltage of which the amplitude varies with that of ac input voltage. The DC-to-DC converter 20 is used for converting the regulated bus voltage to an tight regulated output voltage Vₒᵤₜ.

The boost type PFC pre-regulator 10 includes a rectifier BD1, a boost inductor L11, a boost diode D11, a energy storage capacitor C11, a switch device Q11 and a follower boost PFC controller 30. The rectifier BD1, typically a diode bridge circuit, is used for rectifying the ac input voltage and providing a rectified ac voltage. The switch device Q11, preferably a MOSFET, includes a control gate, source and drain. A first terminal 102 of the boost inductor L11 is electrically connected to the rectifier BD1 and the second terminal 104 of the boost inductor LI1 is electrically connected to the source of the switch device Q11. The boost diode D11 and the energy storage capacitor C11 connected in series are coupled to the switch device Q11 in parallel. Furthermore, a series of Pulse Width Modulated (PWM) voltage pulses are provided by the follower boost PFC controller 30 and injected into the boost type PFC pre-regulator 10 on the gate of the switch device Q11. A signal sensed from the regulated bus voltage V_{reg} is provided to the follower boost PFC controller 30 so that the follower boost PFC controller 30 generates the PWM voltage pulses according to the regulated bus voltage and thereby provides a feedback control to make the shape of the averaged input current flowing the boost inductor L11 follow the shape of the input voltage and produce a high power factor.

The current flowing through the inductor L11 grows up linearly according to a slope (Vᵢₙ/Lp) during the switch device Q11 is on, where Vᵢₙ is the instantaneous input voltage and Lp denotes the inductor value. On the other hand, The current flowing through the inductor L11 decreases linearly according to the slope (V_{reg}−Vᵢₙ)/Lp during the switch device Q11 is off, where V_{reg} is the output voltage of the boost type PFC pre-regulator 10. With the regulated bus voltage by follower boost PFC controller 30, the voltage differentiation between the output and input is reduced. Accordingly, a lower slope decreasing of current in the inductor L11 results in longer off-time duration of Q11, and hence lower power loss in the switch device Q11 compared to conventional constant bus voltage operation for minimum ac input. Meanwhile, the decreased voltage differentiation between the output and input will result in smaller current ripple in the inductor L11, and this leads to a further advantage that the inductor L11 used in the boost type PFC pre-regulator 10 can be selected as a smaller one comparing to traditional systems, and this also improves the conversion efficiency.

The boost regulated bus voltage V_{reg} across the energy storage capacitor C11 is then as an input voltage of the DC-to-DC converter 20. The DC-to-DC converter 20 includes a transformer T21, a symmetrical half-bridge switching device B20, and a rectification circuit R20. The symmetrical half-bridge switching device B20 includes two switches Q21 and Q22 which are programmed to turn on and turn off to generates a symmetrical square waveforms with adjustable duty cycle provided to the transformer T21. The transformer T21 includes a primary winding W1 coupled to the symmetrical half-bridge switching device B20 and a secondary winding W2 coupled to the rectification circuit R20. The transformer T21 thereby is used for coupling the energy from the symmetrical half-bridge switching device B20 to the rectification circuit R20. By appropriate adjustment of duty cycle for the square waveforms that provided to the transformer T21 according to the input bus voltage and load operation condition, a tight regulated dc output voltage can be maintained. As shown in FIG. 2, the rectification circuit R20 further includes two synchronous rectifiers of Q31 and Q32, and a output filter which includes a inductor L31 and a capacitor C31. By employing the arrangement for the DC-to-DC converter as described above, the conversion efficiency of the DC-to-DC converter could be significantly improved especially when designing for wide input range voltage operation in necessary. This is because firstly, the synchronous rectification in the secondary side of transformer will introduce much lower conduction loss since the synchronous rectifiers of Q31 and Q32 will conducting output current with much lower voltage drop comparing to conventional diode rectifiers. Secondary, the two synchronous rectifiers of Q31 and Q32 are controlled to turn on and turn off complementary to that of primary half-bridge switches Q21 and Q22, so that the two synchronous rectifiers Q31 and Q32 conducts output current in the duty time alternately and both of them will conduct output current in the rest time which means further deduction of the power loss in the devices.

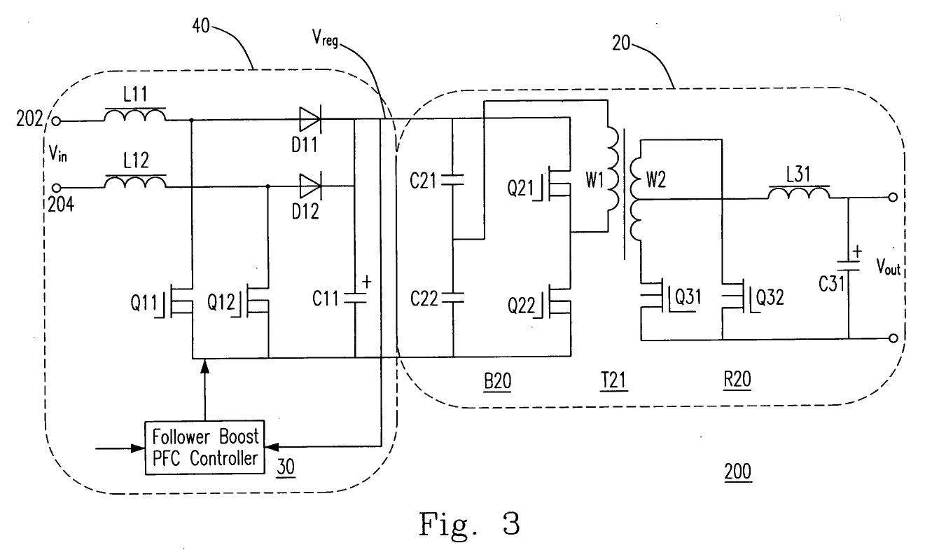

Please refer to FIG. 3, a schematic diagram of a power converter according to the second preferred embodiment of the present invention is illustrated. Comparing this power converter 200 with the first embodiment, the boost type PFC pre-regulator 10 is replaced by a synchronous rectifying dual boost PFC pre-regulator 40 to further save the conduction loss of rectifier BD1 so that overall conversion efficiency could be further improved especially for the operation of minimum input ac voltage. It can be noted in referring to FIG. 3 that the power converter 200 includes certain elements and arrangements of those elements that are similar to those of power converter 100 as illustrated in FIG. 2. For this reason, the reference numerals assigned to the elements in FIG. 2 are repeated in FIG. 3, so that the fundamental differences between the power converter 100 and the power converter 200 can be clearly distinguished.

The synchronous rectifying dual boost PFC pre-regulator 40 in the power converter 200 includes a energy storage capacitor C11 and two boost circuits which are composed by two boost inductors of L11 and L12, and two active switches of Q11 and Q12. As shown in FIG. 3, the two boost circuits are connected inversely with respect to each other to an input ac voltage Vᵢₙ. That is, the input terminal 202 of the first boost circuit is connected from one terminal of the input ac voltage Vᵢₙ, while the return terminal 204 of the first boost circuit is connected to the other terminal of the input ac voltage Vᵢₙ. In an inverse manner, the input terminal 204 of the second boost circuit is connected to one terminal of the input ac voltage Vᵢₙ, while the return terminal 202 of the second boost circuit is connected to the other terminal of the input ac voltage Vᵢₙ. Both of the outputs of the two boost circuits are connected in parallel to the energy storage capacitor C11 to provide a regulated bus voltage to the DC-to-DC converter 20.

Accordingly, the first boost circuit operates during a first half cycle of the ac voltage Vᵢₙ, wherein the terminal 202 is positive with respect to the terminal 204, to provide a current flowing through the inductor L11 to the energy storage capacitor C11, while the second boost circuit operates during a second half cycle of the input ac voltage Vᵢₙ, wherein the terminal 204 is positive with respect to the terminal 202, to provide a current flowing through the inductor L12 to the energy storage capacitor C11.

It also can be noted that the follower boost PFC controller 30, which is preferably composed by a pulse width modulation circuit, is provided to sense the regulated bus voltage across the energy storage capacitor C11 and generate a feedback control signal for controlling the turning on/off of the two active switches of Q11 and Q12. Therefore, with an appropriate on/off control of the two active switches of Q11 and Q12, the dual boost PFC pre-regulator 40 can be performed as the boost switch device and synchronous rectifier. The circuit of the power converter 200 thereby reduces the number of semiconductor elements in the circuit paths through which power is provided to the DC-to-DC converter 20, and thereby further reduces the power losses in the power converter 200 in comparison to the power converter 100.

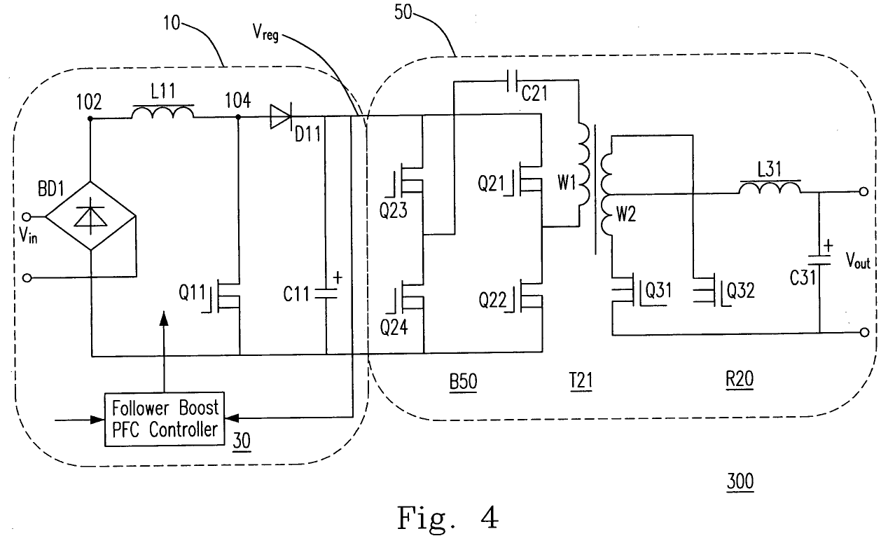

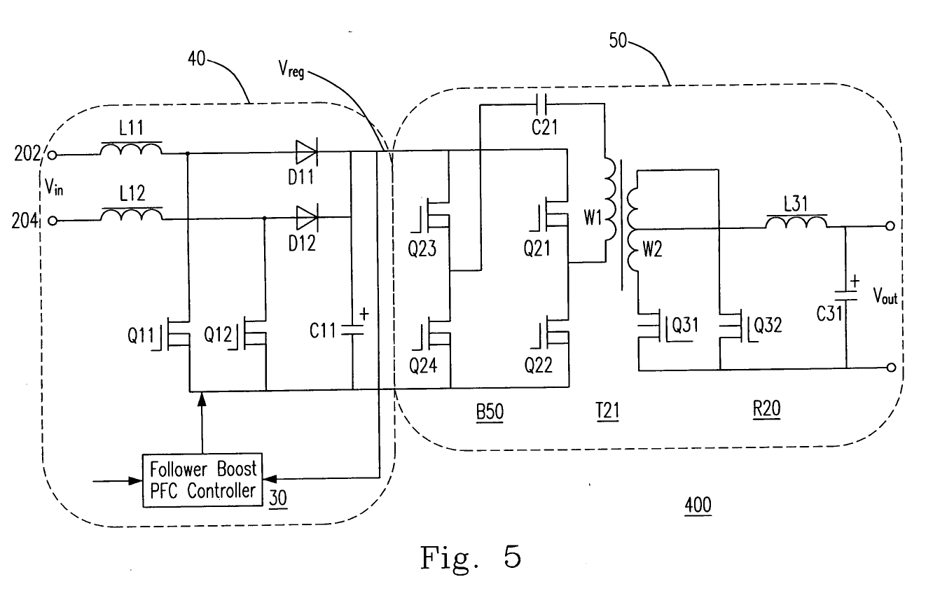

FIG. 4 shows a schematic diagram of a power converter in accordance with the third preferred embodiment of the present invention. In this embodiment of the power converter 300, the boost type PFC pre-regulator 10 is remained unchanged as in the first embodiment shown in FIG. 2, while the symmetrical half-bridge switching device B20 is replaced by a symmetrical full-bridge switching device B50. The DC-to-DC converter 50 thereby includes two bridge type connections of switching devices of Q21 and Q22, Q23 and Q24, and a capacitor C21, a transformer T21, two synchronous rectifiers of Q31 and Q32, and a output filter of L31 and C31. The symmetrical full-bridge switching device B50 is electrically connected to the first winding W1 of the transformer T21, while the rectification circuits R20 are electrically connected to the secondary winding W2 of the transformer T21. Furthermore, FIG. 5 shows a schematic diagram of a power converter in accordance with the fourth preferred embodiment of the present invention. As shown in FIG. 5, the converter 400 combines the changes that mentioned in FIG. 3 and FIG. 4. That is the first part of the power converter 400 is replaced by the synchronous rectifying dual boost PFC pre-regulator 40, while the second part of the power converter 400 is replaced by the symmetrical full-bridge type DC-to-DC converter 50.

As described in the first and the second embodiments of the present invention, the power converters 300 and 400 as illustrated in FIG. 4 and FIG. 5 functions the same as the power converters 100 or 200. Accordingly, it is the feature of the present invention to provide a novel AC-to-DC power converter architecture that adopts a new combination of control strategies and topologies in the PFC pre-regulator and the DC-to-DC converter. The new topologies of the PFC pre-regulator and the DC-to-DC converter are illustrated as in FIG. 2 to FIG. 5. The control strategies of the power converter includes steps of rectifying an input ac voltage from the ac power source to produce a rectified voltage, converting the rectified voltage to a regulated bus voltage by means of a boost converter, detecting the regulated bus voltage by means of a controller and generating a signal in response to the regulated bus voltage to provide a feedback control, preferably to provide a PWM signal, to the boost converter, and converting the regulated bus voltage to a tight regulated output voltage by means of a DC-to-DC converter.

Accordingly, the present invention is able to reduce the conduction loss and improve the conversion efficiency of the boost PFC stage by adopting a follower boost PFC controller. However, the operation of the follower boost PFC pre-regulator would break the optimum operation of the DC-to-DC converter. In the conventional art, the PFC pre-regulator provides a constant bus voltage to the DC-to-DC converter, so that the DC-to-DC converter operates at most of the optimum duty cycle and keeps the best efficiency at the universal input range. When the range of the regulated bus voltage of the pre-regulator is extended, the efficiency of the DC-to-DC converter will degrade as the regulated bus voltage being increased due to the reduction of the duty cycle. However, what is concerned in the present invention is to make sure that the efficiency reduction of the DC-to-DC converter is less than the increase of that of the follower boost PFC pre-regulator at the minimum input ac voltage operation.

On the other hand, the bridge switching device, including the half bridge type and the full bridge type, of the DC-to-DC converter is employed to generate a symmetrical square waveform with an adjustable duty cycle, and to provide an output voltage Vₒᵤₜ through the coupling of transformer. For a predetermined maximum duty cycle operation, the ratio of Vₒᵤₜ/V_{reg} is in inverse proportion to the turn ratio of the primary to the secondary winding of the transformer. When the range of the regulated bus voltage being extended, the turn ratio of primary and secondary winding should be reduced to guarantee the same maximum duty cycle. However, this results in the increasing of the voltage rating for the rectification devices in the output side and hence causes higher conduction loss in the rectifier. Therefore, synchronous rectification circuit by employing MOSFET for the rectifiers of Q31 and Q32 was presented in the invention as an combination for the DC-to-DC converter to achieve low conduction loss in the output side since the MOSFET as synchronous rectifier will conduct the output current with much lower voltage drop comparing to the conventional diode rectifier. Furthermore, the two synchronous rectifier conducts output current in the duty time alternately and both of them will conduct the currents in the rest time which means further deduction of the conduction loss of the rectifier especially when input voltage from pre-regulated bus were extended as wide range.

While the invention has been described in terms of what is presently considered to be the most practical and preferred embodiments, it is to be understood that the invention needs not be limited to the disclosed embodiments. On the contrary, it is intended to cover various modifications and similar arrangements included within the spirit and scope of the appended claims, which are to be accorded with the broadest interpretation so as to encompass all such modifications and similar structures.

1. A power converter, comprising:
a rectifier for generating a rectified voltage form an ac power source;
a boost converter electrically connected to said rectifier for converting said rectified voltage to a regulated bus voltage;
a DC-to-DC converter electrically connected to said boost converter for converting said regulated bus voltage to an output voltage; and
a controller generating a signal in response to said regulated bus voltage to provide a feedback control over said boost converter, so that said regulated bus voltage is further controlled and regulated.

2. The power converter according to claim 1, wherein said rectifier is a diode bridge.

3. The power converter according to claim 1, wherein said boost converter further comprises:
a switch device;
an inductor having a first terminal electrically connected to said rectifier and a second terminal electrically connected to an input of said switch device; and
a diode and a capacitor connected in series and electrically connected to said switch device in parallel.

4. The power converter according to claim 3, wherein said switch device further comprises a control input terminal electrically connected to said controller for receiving said signal, so that a current is controlled by said switch device to flow through said inductor.

5. The power converter according to claim 4, wherein said controller is a pulse width modulation circuit having an input terminal for receiving said regulated bus voltage, and having an output terminal coupled to said control input terminal of said switch device to provide a series of pulses for controlling the duty cycle of said switch device.

6. The power converter according to claim 3, wherein said switch device is a MOSFET device.

7. The power converter according to claim 1, wherein said DC-to-DC converter further comprises:
a transformer having a primary winding and a secondary winding;
bridge switching devices electrically connected to said first winding of said transformer; and
a rectification circuit electrically connected to said secondary winding of said transformer.

8. The power converter according to claim 7, wherein said bridge switching devices are ones of symmetrical half-bridge switching devices and symmetrical full-bridge switching devices.

9. The power converter according to claim 7, wherein said rectification circuit comprises two synchronous rectifiers and an output filter.

10. A power converter, comprising:
a dual boost converter having a first boost circuits and a second boost circuits respectively and electrically connected to an output terminal and a return terminal of an ac power source for converting an AC input voltage to a regulated bus voltage;
a DC-to-DC converter electrically connected to said dual boost converter for converting said regulated bus voltage to an output voltage; and
a controller generating a signal in response to said regulated bus voltage to provide a feedback control over said dual boost converter, so that said regulated bus voltage is further controlled and regulated.

11. The power converter according to claim 10, wherein each of said first and second boost circuits further comprises:
a switch device;
an inductor having a first terminal electrically connected to one terminal of said ac input voltage and a second terminal electrically connected to an input of said switch device; and
a boost diode having a first terminal electrically connected to a first terminal of an energy storage capacitor and a second terminal electrically connected to said second terminal of said inductor.

12. The power converter according to claim 11, wherein said switch device further comprises a control input terminal electrically connected to said controller for receiving said signal so that a current is controlled by said switch device to flow through said inductor.

13. The power converter according to claim 12, wherein said controller is a pulse width modulation circuit having an input terminal for receiving said regulated bus voltage, and having an output terminal coupled to said control input terminal of said switch device to provide a series of pulses for controlling the duty cycle of said switch device.

14. The power converter according to claim 11, wherein said switch device is a MOSFET device.

15. The power converter according to claim 10, wherein said DC-to-DC converter further comprises:
a transformer having a primary winding and a secondary winding;
bridge switching devices electrically connected to said first winding of said transformer; and
a rectification circuit electrically connected to said secondary winding of said transformer.

16. The power converter according to claim 15, wherein said bridge switching devices are ones of symmetrical half-bridge switching devices and symmetrical full-bridge switching devices.

17. The power converter according to claim 15, wherein said rectification circuit comprises two synchronous rectifiers and an output filter.

18. A method for supplying a dc voltage from an ac power source, comprising the steps of:
rectifying an ac input voltage from said ac power source to produce a rectified voltage;
converting said rectified voltage to a regulated bus voltage by means of a boost converter;
detecting said regulated bus voltage by means of a controller and generating a signal in response to said regulated bus voltage to provide a feedback control over said boost converter; and
converting said regulated bus voltage to an output voltage by means of a DC-to-DC converter.

19. The method according to claim 18, wherein said feedback control over said boost converter is to provide a PWM signal for a switch of said boost converter.
